(19) United States
(12) Patent Application Publication
(10) Pub. No.: US 2023/0246300 A1
(43) Pub. Date: Aug. 3, 2023

(54) BATTERY AND MANUFACTURING METHOD OF BATTERY

(71) Applicant: TOYOTA JIDOSHA KABUSHIKI KAISHA, Toyota-shi (JP)

(72) Inventor: Masaharu SENOUE, Seto-shi (JP)

(73) Assignee: TOYOTA JIDOSHA KABUSHIKI KAISHA, Toyota-shi (JP)

(21) Appl. No.: 17/990,921

(22) Filed: Nov. 21, 2022

(30) Foreign Application Priority Data
Jan. 28, 2022 (JP) 2022-011523

(51) Int. Cl. H01M 50/46; H01M 4/139; H01M 50/449; H01M 50/431; H01M 50/443; H01M 50/489; H01M 50/446; H01M 50/426; H01M 50/403; H01M 10/058

(52) U.S. Cl. CPC H01M 50/46; H01M 4/139; H01M 50/449; H01M 50/431; H01M 50/443; H01M 50/489; H01M 50/446; H01M 50/426; H01M 50/403; H01M 10/058; H01M 2004/025

(57) ABSTRACT

A battery includes a first electrode, a second electrode, and a separator. The first electrode includes a first main surface and a second main surface. A plurality of through holes is formed in the first electrode. The through holes penetrate the first electrode from the first main surface to the second main surface. The separator coats an inner wall of each of the through holes. The second electrode is disposed in the through holes. The separator includes a first layer and a second layer. The first layer is disposed between the inner wall and the second layer. The first layer contains a first inorganic particle group having a first average particle size. The second layer contains a second inorganic particle group having a second average particle size. The second average particle size is smaller than the first average particle size.

### CROSS-REFERENCE TO RELATED APPLICATION

This application claims priority to Japanese Patent Application No. 2022-011523 filed on Jan. 28, 2022, incorporated herein by reference in its entirety.

### BACKGROUND

### 1. Technical Field

The present disclosure relates to a battery and a manufacturing method of a battery.

### 2. Description of Related Art

Japanese Unexamined Patent Application Publication No. 2020-123484 (JP 2020-123484 A) discloses an electrode having a plurality of through holes and a separator layer laminated on the inner walls of the through holes.

### SUMMARY

A battery includes a first electrode and a second electrode. The second electrode has polarity different from polarity of the first electrode. A separator is disposed between the first electrode and the second electrode to prevent contact between the first electrode and the second electrode. The separator is an electrically insulating material. The separator is porous and has ion permeability. Usually, electrodes are in the form of a sheet. For the electrodes in the form of a sheet, separators in the form of a film are used. For example, as a separator, a microporous film made of a polyolefin is widely used.

Electrodes having special structures are also being studied. For example, through holes are formed in the first electrode. The inner wall of each of the through holes is coated with a separator. The second electrode is disposed in the through holes having the inner walls coated with the separator. Because the electrodes are not in the form of a sheet, with a separator in the form of a film, it is difficult to prevent the contact between the first electrode and the second electrode.

Therefore, for example, the use of a coating-type separator is considered. That is, coating the inner wall of each of through holes with inorganic particle groups makes it possible to form a coating-type separator. However, according to the new findings of the present disclosure, voids (air bubbles) tend to remain in the coating-type separator formed on the inner wall of each of the through holes. At the positions where the voids exist, dielectric strength is likely to locally be reduced. For example, entering of a part of the electrode into the voids is likely to form short circuit paths. For instance, voids are likely to form pinholes.

An object of the present disclosure is to reduce voids in a coating-type separator formed on the inner wall of each of through holes.

Hereinafter, the technical configuration and operation and effect of the present disclosure will be described. Here, the mechanism of action of the present specification includes an assumption. The mechanism of action does not limit the technical scope of the present disclosure.

1. A battery includes a first electrode, a second electrode, and a separator. The first electrode includes a first main surface and a second main surface. The second main surface is an opposite surface of the first main surface. A plurality of through holes is formed in the first electrode. The through holes penetrate the first electrode from the first main surface to the second main surface.

The separator coats an inner wall of each of the through holes. The second electrode has polarity different from polarity of the first electrode. The second electrode is disposed in the through holes. The second electrode extends along an axial direction of each of the through holes.

The separator includes a first layer having a first thickness and a second layer having a second thickness. The first layer is disposed between the inner wall and the second layer. The first layer contains a first inorganic particle group having a first average particle size. The second layer contains a second inorganic particle group having a second average particle size. The second average particle size is smaller than the first average particle size.

In the coating-type separator, the smaller the particle size of inorganic particle groups is, the smaller the size of voids tends to be. Therefore, the use of inorganic particle groups having a small particle size is expected to reduce voids. However, the smaller the particle size of the inorganic particle groups, the denser the coating-type separator, which can lead to the deterioration of ion permeability. That is, the battery resistance can increase.

In the battery of “1.” described above, the separator includes the first layer and the second layer. The first layer (lower layer) is closer to the inner wall than the second layer (upper layer). The first layer is formed of a first inorganic particle group (large particle group). The second layer is formed of a second inorganic particle group (small particle group). During the formation of the second layer, the voids in the first layer may be filled with a part of the small particle group. That is, it is considered that the voids can be reduced. In addition, the formation of the first layer by the large particle group enables the separator to be properly loose. Therefore, an increase in battery resistance can be reduced.

2. The first electrode may form, for example, a honeycomb core.

That is, in a cross section orthogonal to the axial direction of the first electrode, through holes may be arranged in a honeycomb pattern. The electrode having a honeycomb structure is promising as an electrode having a special structure. The electrode having a honeycomb structure is expected to increase the reaction area and the active material density. That is, input/output characteristics and energy density are expected to be simultaneously satisfied.

It is considered that in a case where the first electrode has a honeycomb structure, it will be difficult to use a separator other than the coating-type separator. It is considered that in a case where the first electrode has a honeycomb structure, it will be difficult to detect defects of the coating-type separator formed on the inner wall of each of the through holes. It is also considered that removing the defects of the coating-type separator without destroying the honeycomb structure will be difficult. The separator in “1.” described above is considered to be effective for electrodes having a honeycomb structure.

3. Voids may be formed in the first layer. The voids may be filled with a part of the second inorganic particle group.

4. The second average particle size may be smaller than the first thickness, for example.

Although the mechanism is unclear, the size of the voids can depend on the thickness (first thickness) of the first layer. In a case where the particle size of the second inorganic particle group is smaller than the first thickness, the voids are expected to be easily filled with the second inorganic particle group.

5. A ratio of the second average particle size to the first thickness may be, for example, 1/300 or less, because then the reduction of voids is expected.

6. The first average particle size may be, for example, 0.3 μm to 2 μm.

7. The first thickness may be, for example, 10 μm to 150 μm.

8. The second thickness may be, for example, 30 μm or less.

9. A ratio of the second thickness to the first thickness may be, for example, 0.5 or less, because then an increase in battery resistance can be suppressed.

10. The first layer may further contain a first binder. The second layer may further contain a second binder.

11. The first inorganic particle group and the second inorganic particle group may each independently include at least one compound selected from the group consisting, of, for example, aluminum oxide, aluminum oxide hydrate, aluminum hydroxide, and titanium oxide.

12. The first electrode may be, for example, columnar. The first main surface and the second main surface may be located at both ends in an axial direction of the first electrode, respectively.

13. The battery may further contain an electrolytic solution.

14. A manufacturing method of a battery includes the following (a) to (c).

(a) Preparing a first electrode in which a plurality of through holes is formed.

(b) Forming a separator that coats an inner wall of each of the through holes.

(c) Disposing a second electrode in the through holes after (b) described above.

The (b) includes the following (b1) and (b2).

(b1) Coating the inner wall of each of the through holes with a first paste to form a first layer.

(b2) Coating a surface of the first layer with a second paste to form a second layer.

The second electrode has polarity different from polarity of the first electrode. The first paste contains a first inorganic particle group having a first average particle size. The second paste contains a second inorganic particle group having a second average particle size. The second average particle size is smaller than the first average particle size.

With the manufacturing method of the “14.”, the battery of the “1.” can be manufactured.

15. The first electrode includes a first main surface and a second main surface. The second main surface is an opposite surface of the first main surface. The through holes penetrate the first electrode from the first main surface to the second main surface.

The (b1) may include aspirating the first paste from the first main surface or the second main surface.

The (b2) may include aspirating the second paste from the first main surface or the second main surface.

The aspiration of the pastes into the through holes makes it possible for the inner wall of each of the through holes to be coated with the pastes.

16. The first paste may further contain a first binder and a first dispersion medium. The second paste may further contain a second binder and a second dispersion medium.

17. The manufacturing method of a battery may further include the following (d).

(d) Impregnating the separator with an electrolytic solution.

Hereinafter, embodiments of the present disclosure (hereinafter, can be simply described as “the present embodiment”) and examples of the present disclosure (hereinafter, can be simply described as “the present example”) will be described. Here, the present embodiment and the present example do not limit the technical scope of the present disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing an example of a battery in the present embodiment;

FIG. 2 is a schematic view showing an example of a first electrode;

FIG. 3 is a schematic cross-sectional view showing a first example of through holes;

FIG. 4 is a schematic cross-sectional view showing a second example of through holes;

FIG. 5 is a schematic cross-sectional view of a battery element;

FIG. 6 is a schematic cross-sectional view of a separator;

FIG. 7 is a schematic flowchart of a manufacturing method of a battery in the present embodiment;

FIG. 8 is a first view showing a process of forming a separator in the present embodiment; and

FIG. 9 is a second view showing a process of forming a separator in the present embodiment.

### DETAILED DESCRIPTION OF EMBODIMENTS

### Definition of Terms, and the Like

In the present specification, “including”, “containing”, “having”, and descriptions which are the modifications (for example, “composed of”) of “including”, “containing”, and “having” are an open-ended form. The open-ended form may or may not include additional elements in addition to essential elements. The description “consisting of” is a closed form. However, even in the closed form, additional elements that are usually accompanying impurities or irrelevant to the technique of the present disclosure art not excluded. The description of “substantially consists of” is a semi-closed form. In the semi-closed form, the addition of elements that substantially do not affect the basic and novel characteristics of the technique of the present disclosure is acceptable.

In the present specification, the expressions such as “may” and “can” do not mean “must” which signifies requisiteness, and are used to mean “be likely to” which signifies acceptability.

Unless otherwise specified, the order of executing a plurality of steps, motions, and operations included in various methods and the like are not limited to the order described in the present specification. For example, a plurality of steps may be simultaneously performed. For example, a plurality of steps may be substantially simultaneously performed.

Geometric terms (for example. “parallel”, “perpendicular”, and “orthogonal”) in the present specification should not be interpreted in a strict sense. For example, “parallel” may be slightly different from “parallel” in a strict sense. Geometric terms in the present specification can include, for example, a design, work, or manufacturing tolerance or error. The dimensional relationships in each drawing sometimes do not agree with the actual dimensional relationships. In order to help the understanding of the technique of the present disclosure, sometimes the dimensional relationships (such as length, width, and thickness) in each drawing are changed. Furthermore, some configurations may not be shown in each drawing in some cases.

In the present specification, unless otherwise specified, a numerical range such as “m % to n %” includes an upper limit and a lower limit. That is, “m % to n %” represents a numerical range of “m % or more and n % or less”. “m % or more and n % or less” includes “more than m % and less than n %”. A numerical value arbitrarily selected from a numerical range may be adopted as a new upper or lower limit. For example, a new numerical range may be set by arbitrarily combining a numerical value within a numerical range with a numerical value described in another part, table, or drawing in the present specification.

In the present specification, all numerical values are modified by the term “about”. The term “about” can mean, for example, ±5%, ±3%, ±1%, and the like. All numerical values can be approximate values that can change depending on the mode of use of the technique of the present disclosure. All numerical values can be expressed in significant figures. A measured value can be an average of values obtained by measurement performed multiple times. The number of times of measurement may be 3 or more, 5 or more, or 10 or more. Generally, it is expected that the reliability of the average will be improved as the number of times of measurement increases. The measured value can be rounded off to the nearest integer based on number of digits of the significant figures. The measured value can include, for example, an error that occurs due to the detection limit of the measuring device or the like.

In the present specification, in a case where a compound is represented by a stoichiometric composition formula (for example, “LiCoO₂”), the stoichiometric composition formula is merely a typical example of the compound. The compound may have a non-stoichiometric composition. For example, in a case where lithium cobalt oxide is represented by “LiCoO₂”, unless otherwise specified, the lithium cobalt oxide is not limited to the composition ratio of “Li/Co/O=1/1/2”, and can contain Li, Co, and O at any composition ratio. Doping or substitution with trace elements and the like are also acceptable.

In the present specification, “solid fraction” means the total mass fraction of solid components in a coating material (for example, a paste). A component dissolved in the dispersion medium is regarded as a solid component.

“Average particle size” in the present specification represents a particle size at which a cumulative frequency of particles having a particle size smaller than the above particle size reaches 50% in a volume-based particle size distribution. The average particle size can be measured by a laser diffraction method.

“Battery” in the present specification can be any battery system. In the present embodiment, as an example, an aspect in which the battery is a lithium ion battery will be described. The second electrode has polarity different from polarity of the first electrode. The first electrode may be a positive or negative electrode. In the present embodiment, as an example, an aspect in which the first electrode is a negative electrode will be described.

Battery

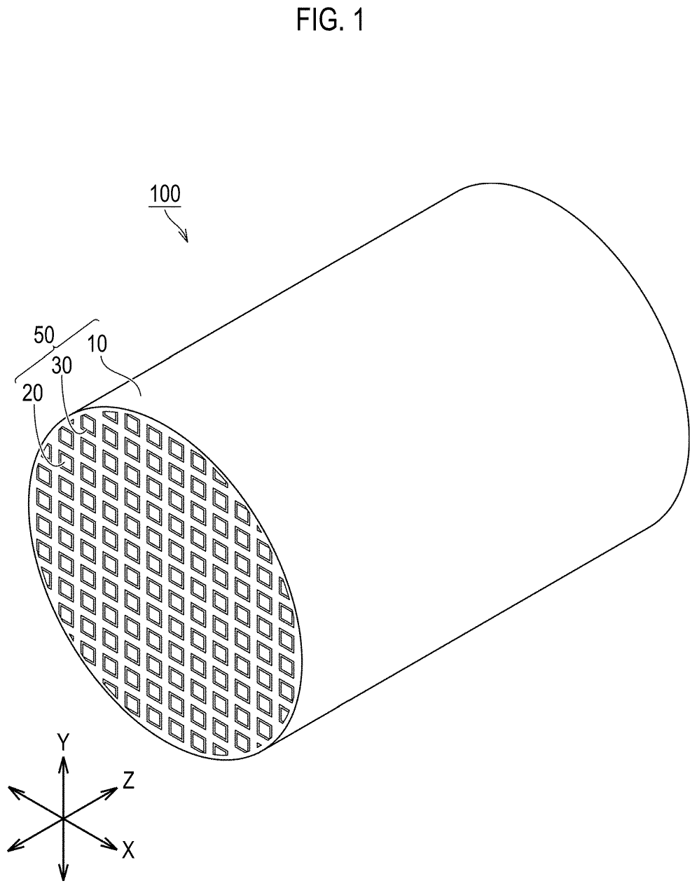

FIG. 1 is a schematic view showing an example of a battery in the present embodiment. Hereinafter, “battery in the present embodiment” can be simply described as “the present battery”. The present battery 100 includes a battery element 50. The present battery 100 may further include, for example, an electrolytic solution and an outer package (none of these are shown in the drawing). The outer package can store the battery element 50 and the electrolytic solution. The outer package may be, for example, a container made of a metal or a pouch made of a metal foil laminate film. The battery element 50 may be impregnated with the electrolytic solution. The battery element 50 includes a first electrode 10, a second electrode 20, and a separator 30. The battery element 50 may further include a current collector, terminals, and the like (none of these are shown in the drawing).

First Electrode

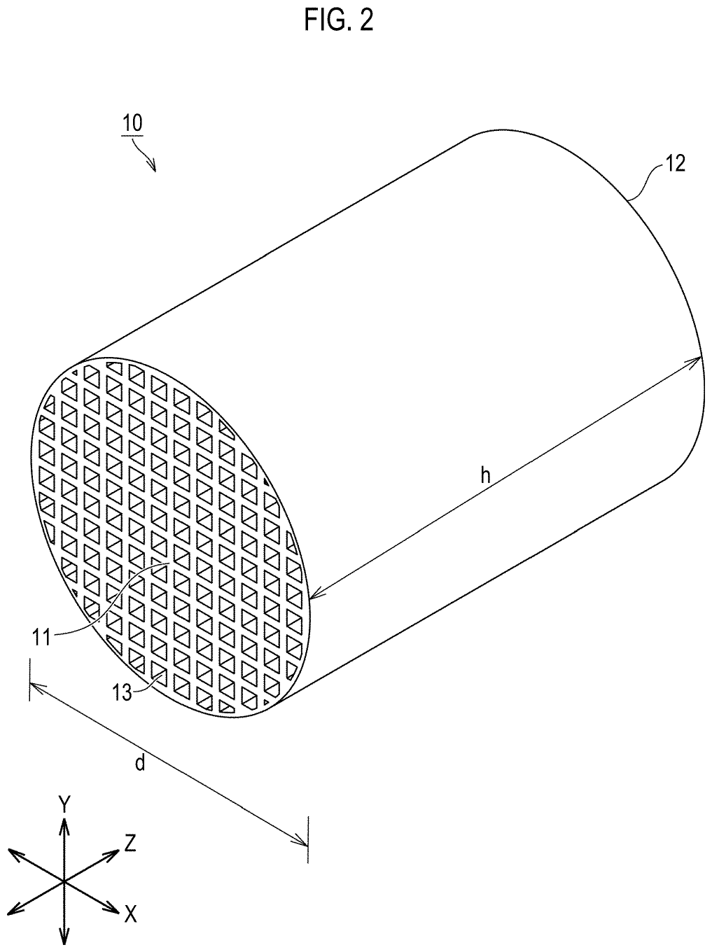

FIG. 2 is a schematic view showing an example of the first electrode. The first electrode 10 can have any shape. The first electrode 10 may be, for example, columnar. The first electrode 10 may be, for example, in the form of a cylinder or prism.

In FIG. 2, the first electrode 10 extends in the Z-axis direction. The direction in which the first electrode 10 extends is also described as “axial direction”. In the present embodiment, a cross section perpendicular to the axial direction is also described as “XY plane”. A cross section parallel to the axial direction is also described as “YZ plane”.

The first electrode 10 has a diameter d. The diameter d represents the maximum width in the XY plane. The diameter d may be, for example, 1 mm to 1,000 mm or 1 mm to 100 mm. The first electrode 10 has a height h. The height h represents the maximum width in the YZ plane. The height h may be, for example, 1 nm to 1,000 nm, 5 nm to 500 nm, or 10 nm to 100 nm. The ratio of the height h to the diameter d may be, for example, 0.1 to 10 or 0.1 to 1.

In the present battery 100, the first electrode 10 is a negative electrode. The first electrode 10 contains a negative electrode active material. The first electrode 10 may further contain a conductive material, a binder, and the like. The first electrode 10 may contain, for example, a binder that makes up 1% to 10% in a mass fraction, a conductive material that makes up 0% to 10% in mass fraction, and a negative electrode active material that makes up the rest.

The negative electrode active material may contain any component. The negative electrode active material may include, for example, at least one material selected from the group consisting of graphite, soft carbon, hard carbon, silicon, silicon oxide, tin, tin oxide, and lithium titanate. The conductive material may include, for example, acetylene black and carbon nanotubes. The binder may include, for example, styrene-butadiene rubber (SBR), and carboxymethylcellulose (CMC).

The first electrode 10 includes a first main surface 11 and a second main surface 12. The first main surface 11 and the second main surface 12 are disposed at both ends in the axial direction. The second main surface 12 is an opposite surface of the first main surface 11. Each of the first main surface 1I and the second main surface 12 may or may not be parallel to the XY plane. Each of first main surface 11 and second main surface 12 may be a flat surface or a curved surface.

A plurality of through holes 13 is formed in first electrode 10. The through holes 13 may be regularly or randomly arranged. The through holes 13 may be in the form of a honeycomb. That is, the first electrode 10 may form a honeycomb core. In the XY plane, the through holes 13 may have a density of 0.1 through holes/mm² to 10 through holes/mm², for example.

The through holes 13 penetrate the first electrode 10 from the first main surface 11 to the second main surface 12. That is, each of the through holes 13 has an opening on each of the first main surface 11 and the second main surface 12. The direction in which the through holes 13 extends (axial direction) may be parallel to the axial direction of the first electrode 10. The through holes 13 can have any cross-sectional shape in the XY plane. The cross-sectional shape of the through holes 13 may be, for example, circular or polygonal. The polygon may be, for example, a triangle or a dodecagon. The polygon may be a regular polygon.

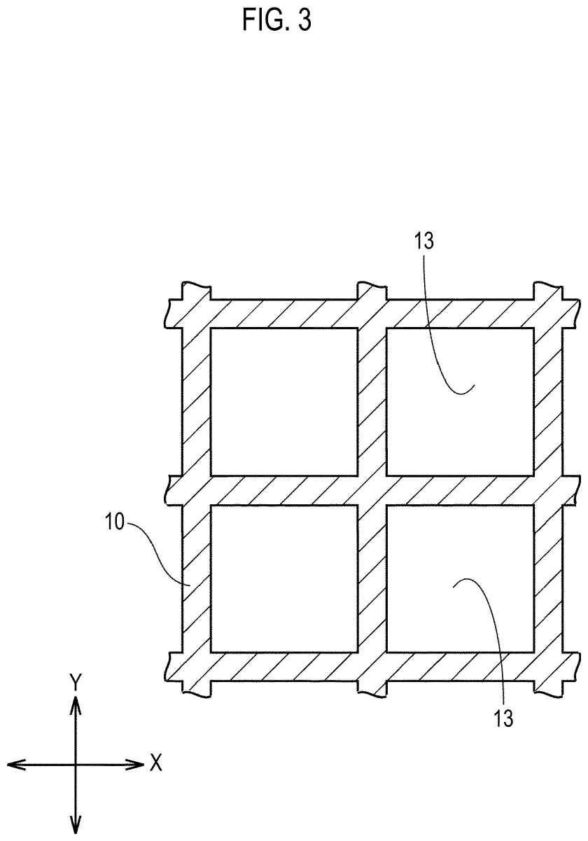

FIG. 3 is a schematic cross-sectional view showing a first example of the through holes. In the XY plane, the cross-sectional shape of the through holes 13 may be square, for example. “Hole diameter” means the maximum width of the through holes 13 in the XY plane. The hole diameter of the through holes 13 may be, for example, 0.1 mm to 10 mm, 0.5 mm to 5 mm, or 1 mm to 3 mm.

The walls that separate the through holes 13 from each other are also called “ribs”. In the XY plane, the ribs may extend, for example, in the form of a mesh. The thickness of each of the ribs may be, for example, 50 μm to 500 μm or 100 μm to 300 μm.

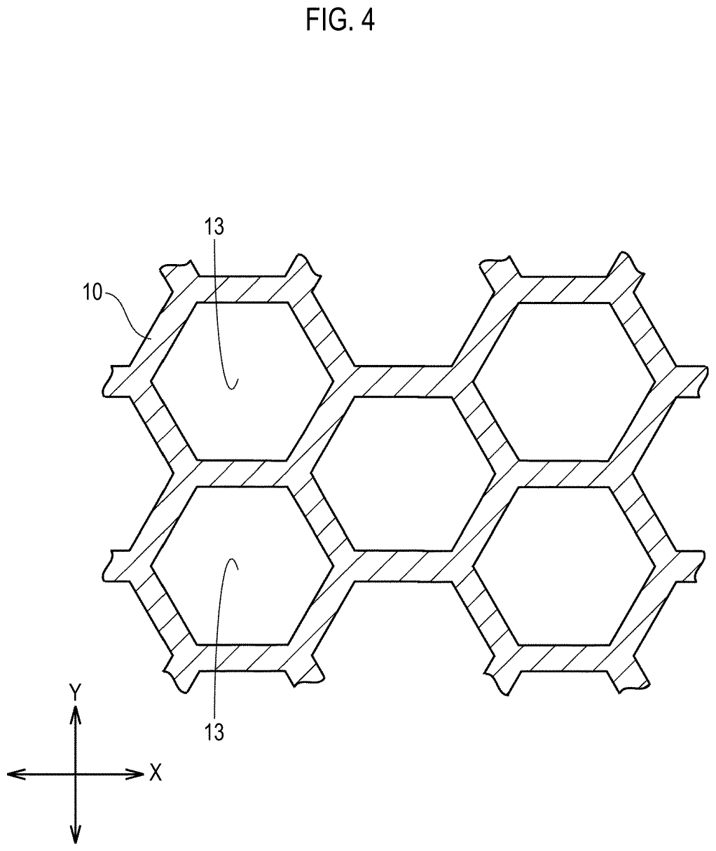

FIG. 4 is a schematic cross-sectional view showing a second example of the through holes. In the XY plane, the planar shape of the through holes 13 may be, for example, hexagonal. The hexagonal planar shape of the through holes 13 tend to mitigate, for example, distortion resulting from charge and discharge.

Separator

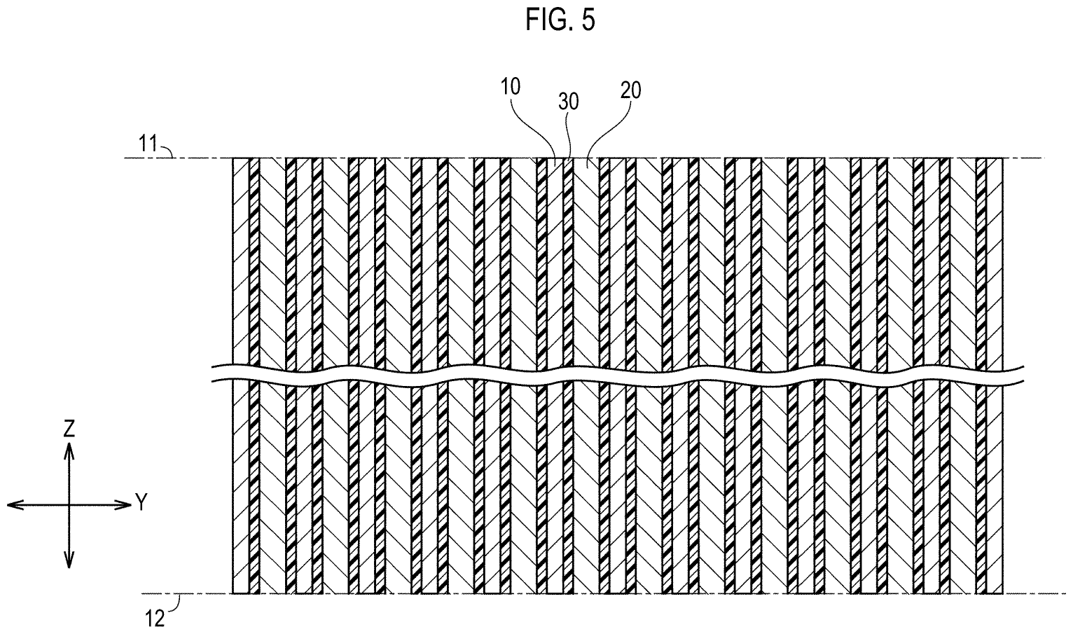

FIG. 5 is a schematic cross-sectional view of a battery element. A separator 30 coats the inner wall of each of the through holes 13. The separator 30 is interposed between the first electrode 10 and the second electrode 20. The separator 30 extends to separate the second electrode 20 from the first electrode 10.

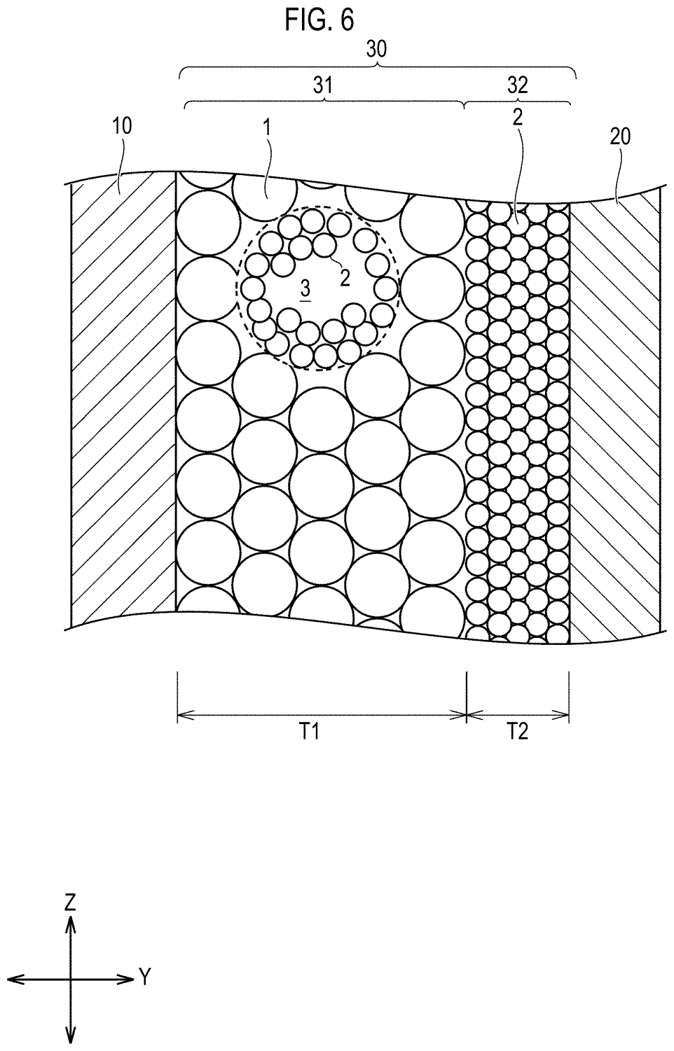

FIG. 6 is a schematic cross-sectional view of the separator. The separator 30 includes a first layer 31 and a second layer 32. The first layer 31 is disposed between the inner wall (first electrode 10) of each of the through holes 13 and the second layer 32. The first layer 31 may be in direct contact with the inner wall. The second layer 32 may be in direct contact with the first layer 31. The second layer 32 may be in direct contact with the second electrode 20.

The first layer 31 has a first thickness T1. The second layer 32 has a second thickness T2. The second thickness T2 may be, for example, equal to or less than the first thickness T1. That is, T1 and T2 may satisfy a relationship of “T2/T1 ≤1”, “T2/T1 <1”, “T2/T1 ≤0.9”, “T2/T1 ≤0.6”, or “T2/T1 ≤0.5”. In a case where the relationship of “T2/T1 ≤0.5” is satisfied, an increase in battery resistance can be reduced. For example, T1 and T2 may satisfy a relationship of “0.3≤T2/T1”.

The first thickness T1 may be, for example, 10 μm to 150 μm, 30 μm to 100 μm, or 30 μm to 70 μm. The second thickness T2 may be, for example, 1 μm to 60 μm, 10 μm to 40 μm, or 10 μm to 30 μm.

The first layer 31 contains a first inorganic particle group 1. The first inorganic particle group 1 has a first average particle size D₁50. The second layer 32 contains a second inorganic particle group 2. The second inorganic particle group 2 has a second average particle size D₂50. The second average particle size D₂50 is smaller than the first average particle size D₁50. That is, D₁50 and D₂50 satisfy a relationship of “D₂50<D₁50”. For example, D₁50 and D₂50 may satisfy a relation relationship “0<D₂50/D₁50 <1”, “0.1<D₂50/D₁50 <1”, “0.125≤D₂50/D₁50 ≤0.5”, or “0.125≤D₂50/D₁50 ≤0.25”.

The first average particle size D₁50 may be, for example, 0.3 μm to 2 μm or 0.8 μm to 1.5 μm. The second average particle size D₂50 may be, for example, 0.05 μm to 0.3 μm or may be 0.1 μm to 0.2 μm.

Voids 3 may be formed in the first layer 31. The voids 3 may be filled with a part of the second inorganic particle group 2. Filling of the voids 3 with a part of the second inorganic particle group 2 is expected to improve the resistance to short circuit. The following Table 1 shows the relationship between the first thickness T1 and the average diameter of the voids 3. The average diameter of the voids 3 can be measured in an X-ray CT image.

TABLE 1
Separator
First layer

| First thickness T1 | Average diameter of voids |
|---|---|
| [μm] | [μm] |
| 30 | 11 |
| 52 | 24 |
| 67 | 26 |
| 80 | 35 |

As shown in the above Table 1, the size of the voids 3 tends to depend on the first thickness T1. The second average particle size D₂50 of the second inorganic particle group 2 may be smaller than the first thickness T1, for example. In a case where D₂50 is smaller than T1, the second inorganic particle group 2 is expected to easily enter the voids 3.

The average diameter of the voids 3 can be ½ to ⅓ of the first thickness T1. The second average particle size D₂50 of the second inorganic particle group 2 may be, for example, equal to or less than ½ of the first thickness T1. That is, D₂50 and T1 may satisfy a relationship of “D₂50/T1 ≤1/2”. For example, D₂50 and T1 may satisfy a relationship of “D₂50/T1 ≤1/3”, “D₂50/T1 ≤1/10”, “D₂50/T1 ≤1/100”, or “D₂50/T1 ≤1/300”. In a case where the relationship of “D₂50/T1 ≤1/300” is satisfied, the resistance to short circuit is expected to be improved.

The first inorganic particle group 1 and the second inorganic particle group 2 include electrically insulating inorganic compounds. The first inorganic particle group 1 and the second inorganic particle group 2 may have the same composition or different compositions. For example, the first inorganic particle group 1 and the second inorganic particle group 2 may each independently include at least one compound selected from the group consisting of aluminum oxide, aluminum oxide hydrate, aluminum hydroxide, and titanium oxide. For example, the first inorganic particle group 1 and the second inorganic particle group 2 may each independently include at least one material selected from the group consisting of alumina, boehmite, gibbsite, and titania.

The first layer 31 may further contain a first binder (not shown in the drawing). The second layer 32 may further contain a second binder (not shown in the drawing). The first binder and the second binder may have the same composition or different compositions. The first binder and the second binder may each independently include at least one compound selected from the group consisting of polyvinylidene fluoride (PVDF), a vinylidene fluoride-hexafluoropropylene copolymer (PVDF-HFP), and polytetrafluoroethylene (PTFE).

The first layer 31 may contain, for example, the first binder that makes up 1% to 20% in a mass fraction and the first inorganic particle group 1 that makes up the rest. The second layer 32 may contain, for example, the second binder that makes up 1% to 20% in a mass fraction and the second inorganic particle group 2 that makes up the rest.

Second Electrode

The second electrode 20 is disposed in the through holes 13. The second electrode 20 may be in the form of a column (pillar). The second electrode 20 extends along the axial direction of the through holes 13. The second electrode 20 may extend to the outside of the through holes 13.

In the present battery 100, the second electrode 20 is a positive electrode. The second electrode 20 contains a positive electrode active material. The second electrode 20 may further contain a conductive material, a binder, and the like. The second electrode 20 may contain, for example, a binder that makes up 1% to 10% in a mass fraction, a conductive material that makes up 1% to 10% in a mass fraction, and a positive electrode active material that makes up the rest.

The positive electrode active material may include any component. The positive electrode active material may include, for example, at least one compound selected from the group consisting of lithium cobalt oxide, lithium nickel oxide, lithium manganate, nickel cobalt lithium manganate, nickel cobalt lithium aluminate, and lithium iron phosphate. The conductive material may include, for example, acetylene black. The binder may include, for example, PVDF.

Electrolytic Solution

The present battery 100 may further contain an electrolytic solution. The electrolytic solution contains a supporting electrolyte and a solvent. The supporting electrolyte is dissolved in the solvent. The supporting electrolyte can include any component. The supporting electrolyte may include, for example, at least one electrolyte selected from the group consisting of LiPF₆, LiBF₄, and Li(FSO₂)₂N. The concentration of the supporting electrolyte may be, for example, 0.5 mol/kg to 2 mol/kg.

The solvent is aprotic. The solvent may include any component. The solvent may include, for example, at least one compound selected from the group consisting of ethylene carbonate (EC), propylene carbonate (PC), butylene carbonate (BC), ethylmethyl carbonate (EMC), dimethyl carbonate (DMC), and diethyl carbonate (DEC). The electrolytic solution may further contain any additive, in addition to the solvent and the supporting electrolyte.

Manufacturing Method of Battery

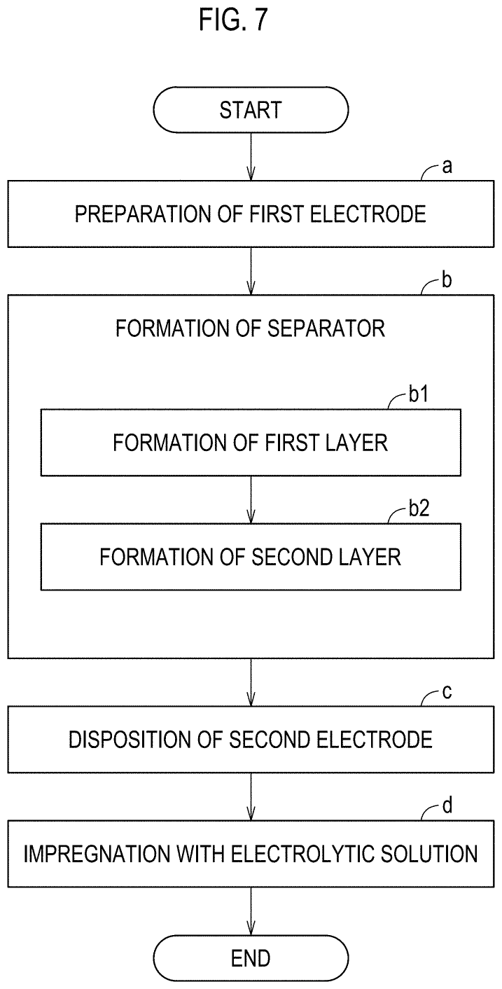

FIG. 7 is a schematic flowchart of the manufacturing method of a battery in the present embodiment. Hereinafter, “manufacturing method of a battery in the present embodiment” will be simply described as “the present manufacturing method”. The present manufacturing method includes “(a) Preparation of first electrode”. “(b) Formation of separator”, and “(c) Disposition of second electrode”. The present manufacturing method may further include, for example, “(d) Impregnation with electrolytic solution”.

(a) Preparation of First Electrode

The present manufacturing method includes the preparation of the first electrode 10. The through holes 13 is formed in first electrode 10. The first electrode 10 can be prepared by any method. For example, the first electrode 10 may be prepared by extrusion molding.

For example, by the mixing of a negative electrode active material, a binder, and a dispersion medium, a negative electrode paste is prepared. For example, an appropriate dispersion medium can be selected according to the type of binder. The dispersion medium may include, for example, water. A mold is prepared. The mold has an extrusion port (die). The extrusion port fits the shape of the first electrode 10. By the extrusion of the negative electrode paste from the extrusion port, a molded article is formed. The molded article is formed to have the through holes 13. By drying of the molded article, the first electrode 10 can be prepared.

(b) Formation of Separator

The present manufacturing method includes the formation of the separator 30. The separator 30 coats the inner wall of each of the through holes 13. That is, the present manufacturing method includes “(b1) Formation of first layer” and “(b2) Formation of second layer”.

(b1) Formation of First Layer

The present manufacturing method includes the formation of the first layer 31 by coating the inner wall of each of the through holes 13 with the first paste. The first paste contains the first inorganic particle group 1. The first paste may further contain the first binder and the first dispersion medium. For example, by the mixing of the first inorganic particle group 1, the first binder, and the first dispersion medium, the first paste can be prepared. For example, according to the type of the first binder, an appropriate material can be selected as the first dispersion medium. The first dispersion medium may include, for example, N-methyl-2-pyrrolidone (NMP).

Any coating method may be used. For example, the first paste may be aspirated from the first main surface 11 or the second main surface 12. For example, the first paste is placed on the first main surface 11. For example, by a vacuum pump, the first paste may be aspirated from the side of the second main surface 12. In this way, the first paste can adhere to the inner wall of each of the through holes 13. Hereinafter, this method will be also described as “aspiration method”. The aspiration method is suitable as a method of coating the inner wall of each of the through holes 13 with a paste. On the other hand, the aspiration method is likely to allow a gas (air bubbles) to be easily mixed into the paste. The gas mixed into the paste is likely to form the voids 3. In the present manufacturing method, the first layer 31 and the second layer 32 are formed in sequence, such that the voids 3 can be reduced.

By the drying of the first paste having adhered to the inner wall, the first layer 31 can be formed. The first thickness T1 of the first layer 31 can be adjusted, for example, by the solid fraction of the first paste. The lower the solid fraction is, the smaller the first thickness T1 tends to be. The solid fraction of the first paste may be, for example, 45% to 65% or 55% to 65%.

(b2) Formation of Second Layer

The present manufacturing method includes the formation of the second layer 32 by coating a surface of the first layer 31 with the second paste. The second paste contains the second inorganic particle group 2. The second paste may further contain a second binder and a second dispersion medium. For example, by the mixing of the second inorganic particle group 2, the second binder, and the second dispersion medium, the second paste can be prepared. For example, according to the type of the second binder, an appropriate material can be selected as the second dispersion medium. The second dispersion medium may include, for example, NMP.

The coating with the second paste may be performed by the aspiration method. That is, the second paste may be aspirated from the first main surface 11 or the second main surface 12. The aspiration method enables the second paste to adhere to the surface of the first layer 31. By the drying of the second paste having adhered to the first layer 31, the second layer 32 can be formed. The second thickness T2 of the second layer 32 can be adjusted, for example, by the solid fraction of the second paste. The solid fraction of the second paste may be, for example, 45% to 65% or 45% to 55%.

(c) Disposition of Second Electrode

The present manufacturing method includes the disposition of the second electrode 20 in the through holes 13 after the formation of the separator 30.

For example, prior to the disposition of the second electrode 20, an insulation treatment may be performed on the end surfaces (the first main surface 11 and the second main surface 12). For example, an electrodeposition method enables resin particle groups to adhere to the end surfaces. In this way, an insulating film (not shown in the drawing) can be formed. The insulating film can inhibit the second electrode 20 and the first electrode 10 from coming into contact with each other when the second electrode 20 is inserted into the through holes. The resin particle groups may include, for example, polyimide.

The second electrode 20 can be disposed by any method. For example, by the mixing of a positive electrode active material, a conductive material, a binder, and a dispersion medium, a positive electrode paste is prepared. For example, the positive electrode paste may be pressed into the through holes 13. In this way, the through holes 13 can be filled with the positive electrode paste. By the drying of the positive electrode paste, the second electrode 20 can be formed.

Through the above process, the battery element 50 can be formed. A current collector may be mounted on the battery element 50. For example, a metal wire may be wound around the surface on the side of the first electrode 10. The metal wire can function as a current collector of the first electrode 10. For example, a metal foil may be attached to at least one of the first main surface 11 and the second main surface 12. The metal foil comes into contact with the second electrode 20. The metal foil can function as a current collector of the second electrode 20. Furthermore, a terminal may be connected to each current collector.

(d) Impregnation with Electrolytic Solution

The present manufacturing method may include the impregnation of the separator 30 with an electrolytic solution. For example, an outer package is prepared. The battery element 50 is housed in the outer package. An electrolytic solution is injected into the outer package. After the injection of the electrolytic solution, the outer package is sealed. The separator 30 can be impregnated with the electrolytic solution. Through the above process, the present battery 100 can be manufactured.

Manufacturing of Test Battery

Test batteries according to Nos. 1 to 9 were manufactured as below. Hereinafter, for example, “test battery according to No. 1” can be abbreviated to “No. 1”.

No. 1

(a) Preparation of First Electrode

The following materials were prepared.

Negative electrode active material: natural graphite (D50: 15 μm)

Binder: CMC

Dispersion medium: deionized water

The negative electrode active material (100 parts by mass), 10 parts by mass of the binder, and 60 parts by mass of the dispersion medium were mixed together, thereby preparing a negative electrode paste. The negative electrode paste was extruded from a mold, thereby forming a molded article. The molded article was dried at 120° C. for 3 hours, thereby forming the first electrode. The first electrode had the following structure.

Outer shape: Cylindrical (diameter: 20 mm, height: 10 mm)

Arrangement of through holes: regular (honeycomb pattern)

Through holes: regular hexagon (length of one side: 700 μm, thickness of rib: 200 μm)

(b) Formation of Separator

(b1) Formation of First Layer

The following materials were prepared.

First inorganic particle group: boehmite (D₁50: 0.5 μm)

First binder: PVDF (trade name “KF Polymer”, grade “#8500”, manufactured by KUREHA CORPORATION)

First dispersion medium: NMP

The first inorganic particle group (57 parts by mass), 5 parts by mass of the first binder, and 38 parts by mass of the first dispersion medium were mixed together, thereby preparing the first paste. The first paste in an amount of 3 g to 5 g was placed on the first main surface of the first electrode. By a vacuum pump, the first paste was aspirated into the through holes from the side of the second main surface. In this way, the first paste adhered to the inner wall of each of the through holes. The first electrode (honeycomb electrode) to which the first paste had adhered was dried at 120° C. for 15 minutes. In this way, the first layer was formed. The average thickness (first thickness) of the first layer was measured with an optical microscope. The first thickness was 65 μm.

(b2) Formation of Second Layer

The following materials were prepared.

Second inorganic particle group: aluminum oxide (D₂50: 0.1 μm)

Second binder: PVDF (trade name “KF Polymer”, grade “#8500”, manufactured by KUREHA CORPORATION)

Second dispersion medium: NMP

The second inorganic particle group (45 parts by mass), 7 parts by mass of the second binder, and 48 parts by mass of the second dispersion medium were mixed together, thereby preparing the second paste. The second paste in an amount of 3 g to 5 g was placed on the first main surface of the first electrode. By a vacuum pump, the second paste was aspirated into the through holes from the side of the second main surface. In this way, the second paste adhered to a surface of the first layer. The first electrode to which the second paste had adhered was dried at 120° C. for 15 minutes. In this way, the second layer was formed. The total thickness of the separator (total thickness of the first layer and the second layer) was measured with an optical microscope. The total thickness of the separator was 87 μm. That is, the thickness of the second layer (second thickness) was 22 μm.

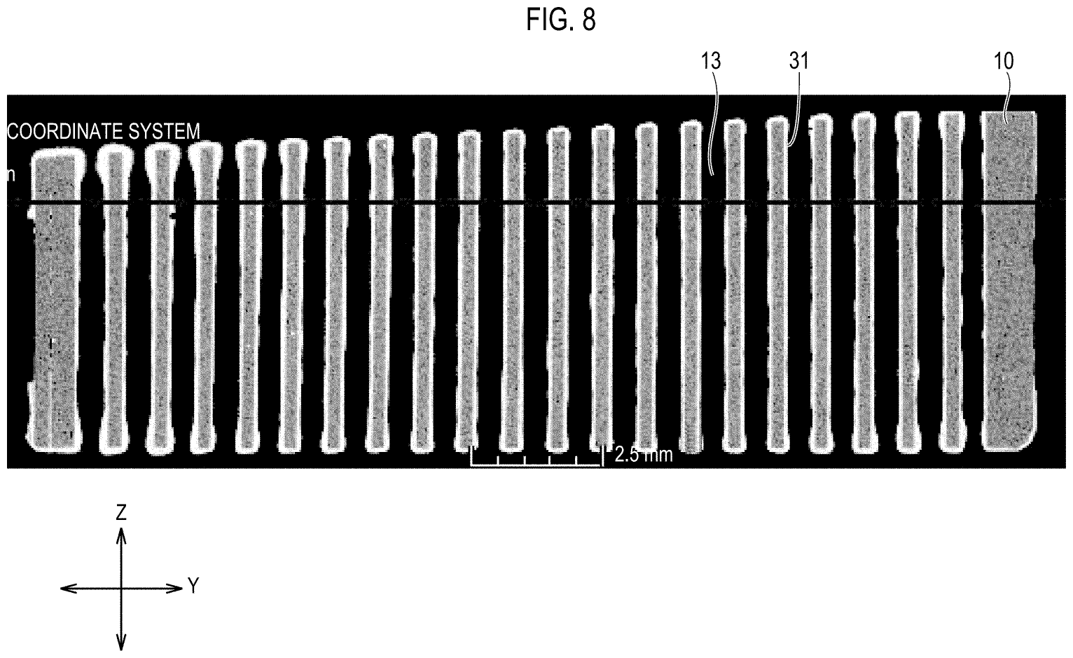

FIG. 8 is a first view showing a process of forming a separator in the present example. FIG. 8 shows an X-ray CT image after the formation of the first layer 31. The through holes 13 is formed in the first electrode 10 (honeycomb electrode). The inner wall of each of the through holes 13 is coated with first layer 31.

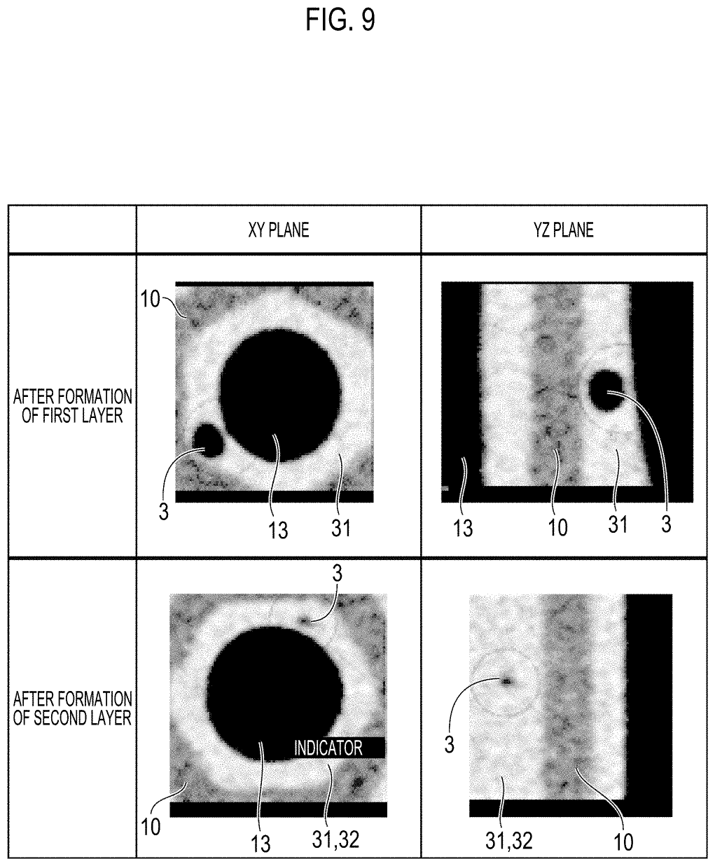

FIG. 9 is a second view showing a process of forming a separator in the present example. FIG. 9 shows an X-ray CT image after the formation of the first layer 31 and an X-ray CT image after the formation of the second layer 32. After the formation of the first layer 31, spherical voids 3 are seen in the first layer 31. After the formation of the second layer 32 (after the formation of the separator 30), the voids 3 are reduced. It is considered that this is because the voids 3 are filled with a part of the second inorganic particle group 2.

(c) Disposition of Second Electrode

An electrodeposition coating material (trade name “ELECOAT PI”, manufactured by Shimizu co. ltd.) was prepared. The electrodeposition coating material contained a dispersoid and a dispersion medium. The dispersoid contained a resin particle group (polyimide). The dispersion medium contained water. A flat Ni wire (thickness: 50 μm, width: 3 mm) was prepared. The flat Ni wire was wound around the lateral surface of the first electrode. The flat Ni wire was connected to a power source. The first electrode was immersed in the electrodeposition coating material. By using the first electrode as a cathode and a working electrode as an anode, a voltage of 30 V was applied for 2 minutes. In this way, the first main surface and the second main surface were coated with an insulating film. After the insulating film was formed, the first electrode was gently washed with water, such that an excess of electrodeposition coating material was removed. After the washing, the first electrode was treated with heat at 180° C. for 1 hour.

The following materials were prepared.

Positive electrode active material: lithium cobalt oxide (D50: 10 μm)

Conductive material: Acetylene black

Binder: PVDF (trade name “KF Polymer”, grade “#1300”, manufactured by KUREHA CORPORATION)

Dispersion medium: NMP

The positive electrode active material (64 parts by mass), 4 parts by mass of the conductive material, 2 parts by mass of the binder, and 30 parts by mass of the dispersion medium were mixed together, thereby preparing a positive electrode paste. A plastic syringe was prepared. The first electrode (honeycomb electrode) was fixed in the barrel of the syringe. In the barrel, 3.5 g of the positive electrode paste was disposed between the first electrode and the plunger. By the plunger, the positive electrode paste was pushed into the first electrode. That is, the positive electrode paste was pressed into the through holes. At a point in time when the positive electrode paste was discharged from an opening portion opposite to the side where the positive electrode paste was pushed in, the pushing of the plunger was stopped. After the positive electrode paste was pressed in, the first electrode was dried at 120° C. for 3 hours. In this way, the second electrode was formed in the through holes. Through the above process, the battery element was formed.

In the battery element, direct current resistance between the first electrode and the second electrode was measured with a tester. In the following Table 2, “OK” means that the direct current resistance was 1 MO or more. “NG” means that the direct current resistance was less than 1 MO. In a sample yielding a result of “OK”, the direct current resistance exceeded the measurement limit.

Each of the first main surface and the second main surface was coated with 0.5 g of the positive electrode paste. By using the positive electrode paste as an adhesive, an aluminum (Al) foil was attached to the first main surface and the second main surface. The Al foil is a current collector of the first electrode (positive electrode). The Al foil had a thickness of 15 μm. The battery element was dried at 120° C. for 15 minutes. A flat Ni wire (thickness: 50 μm, width: 3 mm) was wound once around the lateral surface (circumferential surface) of the second electrode. The flat Ni wire is a current collector of the second electrode (negative electrode). A lead tab (terminal) made of stainless steel was welded to each of the Al foil and the flat Ni wire.

(d) Impregnation with Electrolytic Solution

As an outer package, a pouch made of an aluminum laminate film was prepared. The battery element was housed in the outer package. An electrolytic solution (5 g) was injected into the outer package. After the injection of the electrolytic solution, the outer package was vacuum sealed. The electrolytic solution had the following composition.

Composition of Electrolytic Solution

Supporting electrolyte: LiPF₆ (concentration: 1 mol/kg)

Solvent: “EC/EMC/DMC=1/1/1 (volume ratio)”

Through the above process, a test battery was manufactured. The design capacity of the test battery was 400 mAh.

Initial Charge and Discharge

Charge, pause, and discharge were sequentially performed under the following conditions.

Charge: CCCV, CC current=40 mA, CV voltage=4.2V, cut-off current=10 mA, pause: 10 minutes

Discharge: CCCV, CC current=40 mA, CV voltage=3V, cut-off current=10 mA

“CC” represents a constant current mode, “CV” represents a constant voltage mode, and “CCCV” represents a constant current-constant voltage mode.

After the initial charge and discharge, the voltage of the test battery was adjusted under the following conditions.

Charge: CCCV, CC current=40 mA, CV voltage=3.85 V, cut-off current=10 mA

After the voltage was adjusted, the test battery was discharged for 5 seconds with a CC current of 200 mA. Five seconds after the start of discharge, an amount of voltage drop was measured. Battery resistance was obtained from the amount of voltage drop and the discharge current. The battery resistance is shown in the following Table 2.

Nos. 2 to 9

Test batteries having separators shown in the following Table 2 were manufactured. The first thickness and the second thickness were adjusted by the solid fraction of the first paste and the second paste.

In No. 6, instead of boehmite, titanium oxide was used as the first inorganic particle group.

In No. 9, no second layer was formed. That is, in No. 9, the separator consists of the first layer. The battery resistance was not measured in No. 9 because insulation was insufficient in No. 9.

TABLE 2
Table 2

| | Separator | | | | | | | |
|---|---|---|---|---|---|---|---|---|
| | First layer | | Second layer | | | | | |
| | First average | First | Second average | Second | | | Evaluation | |
| | particle size | thickness | particle size | thickness | ratio | | Insulation | Battery |
| | D₁50 | T1 | D₂50 | T2 | D₂50/T1 | T2/T1 | test | resistance |
| No. | [μm] | [μm] | [μm] | [μm] | [—] | [—] | [—] | [Ω] |
| 1 | 0.8 | 65 | 0.2 | 22 | 1/325 | 0.34 | OK | 6.5 |
| 2 | 0.8 | 60 | 0.2 | 21 | 1/300 | 0.35 | OK | 6.1 |
| 3 | 0.8 | 30 | 0.1 | 13 | 1/300 | 0.43 | OK | 5.4 |
| 4 | 1.5 | 70 | 0.2 | 20 | 1/350 | 0.29 | OK | 8.1 |
| 5 | 0.8 | 65 | 0.2 | 28 | 1/325 | 0.43 | OK | 9.0 |
| 6 | 0.9 | 64 | 0.2 | 22 | 1/320 | 0.34 | OK | 6.5 |
| 7 | 0.8 | 65 | 0.2 | 40 | 1/410 | 0.62 | OK | 27.1 |
| 8 | 0.8 | 65 | 0.1 | 60 | 1/410 | 0.92 | OK | 60.7 |
| 9 | 0.8 | 65 | | | | | NG | |

Results

In Nos. 1 to 8, sufficient insulation was achieved. In Nos. 1 to 8, the separator has the first layer and the second layer, and the second average particle size is smaller than the first average particle size. It is considered that voids may be reduced in Nos. 1 to 8.

In No. 9, insulation was insufficient. In No. 9, the separator has a single layer structure. It is considered that large voids may remain in No. 9.

The battery resistance of Nos. 1 to 6 is lower than the battery resistance of Nos. 7 and 8. In Nos. 1 to 6, the relationship of “T2/T1 ≤0.5” is satisfied.

The present embodiment and the present example are merely examples in all respects. The present embodiment and the present example are not restrictive. The technical scope of the present disclosure includes all modifications within the meaning and scope equivalent to the description of CLAIMS. For example, extracting arbitrary configurations from the present embodiment and present example and arbitrarily combining the configurations are preconceived from the first.

What is claimed is:

1. A battery comprising:
a first electrode;
a second electrode; and
a separator, wherein:
the first electrode includes
a first main surface, and
a second main surface;
the second main surface is an opposite surface of the first main surface;
a plurality of through holes is formed in the first electrode;
the through holes penetrate the first electrode from the first main surface to the second main surface;
the separator coats an inner wall of each of the through holes;
the second electrode has a polarity different from a polarity of the first electrode;
the second electrode is disposed in the through holes;
the second electrode extends along an axial direction of the through holes;
the separator includes
a first layer having a first thickness, and
a second layer having a second thickness;
the first layer is disposed between the inner wall and the second layer;
the first layer contains a first inorganic particle group having a first average particle size;
the second layer contains a second inorganic particle group having a second average particle size; and
the second average particle size is smaller than the first average particle size.

2. The battery according to claim 1, wherein the first electrode forms a honeycomb core.

3. The battery according to claim 1, wherein voids are formed in the first layer and filled with a part of the second inorganic particle group.

4. The battery according to claim 1, wherein the second average particle size is smaller than the first thickness.

5. The battery according to claim 1, wherein a ratio of the second average particle size to the first thickness is 1/300 or less.

6. The battery according to claim 1, wherein the first average particle size is 0.3 μm to 2 μm.

7. The battery according to claim 1, wherein the first thickness is 10 μm to 150 μm.

8. The battery according to claim 1, wherein the second thickness is 30 μm or less.

9. The battery according to claim 1, wherein a ratio of the second thickness to the first thickness is 0.5 or less.

10. The battery according to claim 1, wherein:
the first layer further contains a first binder; and
the second layer further contains a second binder.

11. The battery according to claim 1, wherein the first inorganic particle group and the second inorganic particle group each independently include at least one compound selected from the group consisting of aluminum oxide, aluminum oxide hydrate, aluminum hydroxide, and titanium oxide.

12. The battery according to claim 1, wherein:
the first electrode is columnar; and
the first main surface and the second main surface are located at both ends in an axial direction of the first electrode, respectively.

13. The battery according to claim 1, further comprising an electrolytic solution.

14. A manufacturing method of a battery, the manufacturing method comprising:
preparing a first electrode in which a plurality of through holes is formed;
forming a separator coating an inner wall of each of the through holes; and
disposing a second electrode in the through holes after, wherein:
the includes
forming a first layer by coating the inner wall of each of the through holes with a first paste, and
forming a second layer by coating a surface of the first layer with a second paste;
the second electrode has a polarity different from a polarity of the first electrode;
the first paste contains a first inorganic particle group having a first average particle size;
the second paste contains a second inorganic particle group having a second average particle size; and
the second average particle size is smaller than the first average particle size.

15. The manufacturing method according to claim 14, wherein:
the first electrode includes a first main surface and a second main surface;
the second main surface is an opposite surface of the first main surface;
the through holes penetrate the first electrode from the first main surface to the second main surface;
the includes aspirating the first paste from the first main surface or the second main surface; and
the includes aspirating the second paste from the first main surface or the second main surface.

16. The manufacturing method according to claim 14, wherein:
the first paste further contains
a first binder, and
a first dispersion medium; and
the second paste further contains
a second binder, and
a second dispersion medium.

17. The manufacturing method according to claim 14, the manufacturing method further comprising impregnating the separator with an electrolytic solution.
